(19) United States
(12) Patent Application Publication
(10) Pub. No.: US 2021/0309361 A1
(43) Pub. Date: Oct. 7, 2021

(54) Apparatus, Systems and Methodologies Configured to Enable Electrical Output Management of Solar Energy Infrastructure, Including Management via Remotely Operated Coating Application System and/or Wireless Monitoring Systems

(71) Applicant: Solar Developments Pty Ltd, Dural (AU)

(72) Inventor: James Douglas Foran, Caringbah (AU)

(21) Appl. No.: 17/268,386

(22) PCT Filed: Aug. 15, 2019
(86) PCT No.: PCT/AU2019/050853

§ 371 Date: Feb. 12, 2021

(30) Foreign Application Priority Data
Aug. 15, 2018 (AU) 2018902989

(51) Int. Cl. B64C 39/02; G08G 5/00; B64D 1/16; B05D 1/02; B05C 5/02

(52) U.S. Cl. CPC B64C 39/024; G08G 5/0069; G08G 5/0034; B64C 2201/12; B05D 1/02; B05C 5/02; B64D 1/16

(57) ABSTRACT

Apparatus, systems and methods for dispensing a coating material onto a solar power infrastructure unit (140), such as solar panel arrays (140), in order to reduce their electrical output to negligible levels and/or safe levels. An Unmanned Aerial Vehicle (UAV) (120, 130) or drone with a suitable dispensing apparatus (124) may be adapted and improved in order to apply the coating material to the solar power unit (140). The UAV (120, 130) may be remotely controlled and/or operate autonomously.

### FIELD OF THE INVENTION

The present invention relates to apparatus, systems and methodologies configured to enable management of an electrical output of solar energy infrastructure, including management via remotely operated coating application systems and/or wireless monitoring systems. Embodiments have been developed thereby to assist in situations, including but not limited to system maintenance procedures, and/or emergency response situations (such as fires, floods and the like), where there is a desire to electrically neutralise solar infrastructure for safety and/or other reasons. However, it should be appreciated that the invention is not limited to such applications.

### BACKGROUND

Any discussion of the background art throughout the specification should in no way be considered as an admission that such art is widely known or forms part of common general knowledge in the field.

As energy costs rapidly rise, society is desperately searching for ways to reduce greenhouse gas emissions. Solar energy has become one of the most widely employed of the options being considered as an alternative energy source. A solar cell (also called photovoltaic cell or photoelectric cell) is a solid state electrical device that converts the energy of light directly into electricity by the photovoltaic effect. Assemblies of cells are used to make solar modules which are used to capture energy from sunlight, and which are commonly known as solar panels.

Interest in solar energy technology is rapidly on the rise, with many government bodies and industry pouring millions of dollars each year into conducting research into ever more efficient cells. It has been estimated that photovoltaic cell production has been doubling every two years and is the world's fastest growing energy technology. It is also estimated that about 2% of Australian homes have solar panel systems installed, which is forecast to rise substantially over the coming decades. Other countries have already adopted the technology to a greater degree, with some countries having solar panel systems installed on more than 5% of dwellings. Solar technology is not just applicable to urban buildings; it also finds particular utility in commercial, remote or rural/remote applications where it is difficult or costly to connect mains/grid electricity power and, due to advances in efficiency, in commercial and industrial applications. Beyond that, large scale installations, such as solar farms, are becoming more prevalent.

Solar panels installed on the roof of a building absorb sunlight during the day and instantly convert it into direct current (DC) electrical energy. The electricity is then run into an inverter that converts the DC power into standard alternating current (AC) for use in the home. This electricity is synchronized with the utility/grid power whenever the solar grid is producing electricity, and the electrical panel distributes the solar energy and utility power throughout the home. In some instances it is not uncommon during peak sunlight hours for the utility meter to spin backwards when the solar electricity generated exceeds the home's needs. In this case, the excess power can be sold back to the utility company for a credit. Utility power is automatically provided at night and during times when the home's demand exceeds the solar production. Some systems also include batteries that store electrical energy for use when the sun is not shining.

There are issues, however, associated with solar panel systems, and in particular the safety challenges they present to fire fighters and emergency workers. For example, in 2002 a fire fighter in Switzerland was injured as the result of an electrical shock he received from a solar panel, and in 2007 a fire fighter in Arizona, USA received an indirect electrical shock while fighting a house fire. In this case, the home electricity was secured at the utility switchboard metering box, however the fire fighters operating at this incident were unaware that the solar panel system was still energized. Accordingly, fire fighters and emergency workers are now almost universally trained that when conducting fire ground operations on a building with a solar panel system, the solar panel system must be assumed to be still energized at all times. In other words, even if a building's electrical utilities are shut down at a grid level, everything electrically upstream of an inverter must be assumed to be still energized. Whilst it is known that environmental factors can affect a solar panel system's performance, e.g. cloud cover, smog, and temperature, fire fighters and emergency workers are nevertheless trained to always treat the system as if it were energized electrical equipment.

In an attempt to circumvent this problem, some fire fighters have attempted to black out the solar panel system by using a salvage cover or tarpaulin to block out the sunlight. In these cases, the energy created by the system can be reduced, but this solution does not completely block out the sun, and the system can still produce enough electricity to shock or injure a potential victim. This also means that a fire fighter and emergency worker has to climb onto the roof and install the cover, which presents its own dangers. Furthermore, in high wind conditions it is not uncommon for the cover to be blown off, or even inadvertently removed or partially displaced by the high powered jet of water from the fire fighting equipment.

In another solution, some fire fighters have attempted to cover solar panels with standard fire fighting foam to block out the sunlight, however it has been found that this provided a similar result, namely, sunlight was still able to penetrate through the foam and the solar panel system continued to create electrical energy. In this particular example, it was found that the foam had a tendency to slide off the panels.

There are other electrical dangers which solar panels present. For example, if a fire fighter or and emergency worker were to break the glass protecting a solar cell, this could potentially discharge all of the inherent energy in the system, which could be deadly. Further, fire fighters and emergency workers must be extremely cautious when entering an attic or a roof cavity of a structure with a solar cell system on the roof as exposed wires can fall through the roof into the cavity and shock rescue personnel.

Other dangers relate to the solar cells themselves, which include the use of many hazardous chemicals. To explain, during a fire or an explosion a solar cell can release these hazardous chemicals and present an inhalation hazard to fire fighter and emergency workers working around them and any civilians downwind. In the case of a small residential system, the exposure hazard is relatively small. Larger arrays like those found on some commercial buildings, however, are more likely to be an exposure hazard for fire fighter and emergency workers and the public.

Once a fire has been extinguished, a solar panel continues to present a real danger to those who are employed to clean up the site. Even if the structure has collapsed and the solar panel is buried underneath rubble it is still possible for the panel to produce an electrical current. Other issues can be caused during flooding. For example, if the mains power switchboard is underneath the water line and the roof structure remains above the waterline the panels will still be able to generate electrical power.

One other problem which solar panels present, is that the “hot stick” sensor many fire departments carry on their engines and ladders detects may only alternating current and using a hot stick to determine if a solar panel system is energized will mislead fire fighters into a false sense of security because everything between the solar cells and the inverter is direct current. Although there may be no current, the wires from the array will have a voltage potential that cannot be detected through non contact means.

It will also be understood that the safety of the fire fighter and other emergency workers is paramount, and typically modern fire fighting units engage in “dynamic risk assessment”, which commences from when the fire fighters depart the station. In other words, information on the fire itself, the type of the building on fire, its potential contents, and even information on the surrounding buildings is fed back to the fire fighters before and whilst in transit to the fire. In this way, they can arrive at the fire fully informed and are therefore able to make quick and educated decisions. The fire fighters will not commence operations, however, until the risks have been identified and minimised, and in cases where there are solar panels present valuable time can be wasted in rendering the panels safe by conventional methods. Life and property can be put at risk due to this delay.

PCT patent application publication no. WO/2014/015360 discloses technology whereby electrical risks associated with solar panels are able to be neutralised via application of a coating. This provides a solution to certain issues disclosed above, but there are further challenges in both: (i) application of the coating in scenarios where solar infrastructure is in a challenging location (for example building tops and/or remote locations); (ii) large, industrial scale solar infrastructure; and (iii) determining whether a coating has been effectively applied (a challenge with is amplified where solar infrastructure is in a challenging location).

It is an object of the present invention to overcome or ameliorate one or more of the disadvantages of the prior art, or at least to provide a useful alternative.

### SUMMARY OF THE INVENTION

It is an object of the present invention to overcome or ameliorate at least one of the disadvantages of the prior art, or to provide a useful alternative.

According to a first aspect of the invention there is provided a method of operating an Unmanned Aerial Vehicle (UAV) for applying a coating to a solar power infrastructure unit, the method including: identifying the solar power infrastructure unit; processing input data thereby to determine an orientation of the solar infrastructure unit, wherein the orientation defines a longitudinal axis and a lateral axis of a surface plane; and defining a flight plan that is configured to enable dispensing of a coating material from the UAV; wherein the flight plan is defined to cause application of the coating material across the surface plane of the solar power infrastructure unit substantially along either the longitudinal axis or the lateral axis.

Preferably identifying the solar power unit includes identifying a signal emitted by a transmitter beacon. Preferably the identifying is performed by the UAV. Preferably the identifying is performed by a control device that is in communication with the UAV.

Preferably a transmitter beacon is located at a defined position relative to the solar panel. Preferably, the defined location enables determination of the orientation and defining of the flight plan. Preferably the signal emitted by transmitted beacon enables identification of data representative of the defined position. Preferably wherein the signal emitted by transmitted beacon provides data that is processed thereby to define the flight plan. Preferably the signal emitted by transmitted beacon provides includes enables accessing of data thereby to define a waypoint-based flight plan. Preferably the transmitter beacon is configured to provide a signal having predefined attributes only when electrical output of the solar power infrastructure unit exceeds a predefined threshold. Preferably the beacon is coupled to a power supply provided by the solar power infrastructure unit, wherein the coupling is configured such that the beacon is at least partially deactivated upon electrical output of the solar power infrastructure unit ceasing to exceed the predefined threshold. Preferably the beacon is coupled to a power supply provided by the solar power infrastructure unit, wherein the coupling is configured such that the beacon is able to provide the wireless signal for at least a limited time period upon electrical output of the solar power infrastructure unit ceasing to exceed the predefined threshold.

Preferably the coating material is configured or formulated to affect the electrical output of the solar infrastructure unit, and wherein the beacon is configured to enable remote identification of electrical output of the solar power infrastructure unit ceasing to exceed the predefined threshold. Preferably the transmitted beacon transmits via WiFi. Preferably the signal emitted by the transmitter beacon is representative of, or provides access to, data including any one of the following: a unique identifier for the solar power infrastructure unit; operational attributes of the solar power infrastructure unit; a location of the solar power infrastructure unit; orientation of the solar power infrastructure unit relative to known parameters; and a predefined flight plan configured for applying the coating to the solar power infrastructure unit.

Preferably including processing input data to determine an orientation of the solar infrastructure unit, wherein the orientation defines a longitudinal axis and a lateral axis of a surface plane includes processing input data collected by a sensor device of the UAV. Preferably the sensor device includes an optical sensor device or an infrared sensor device.

Preferably the flight plan additionally includes a flight plan component configured to perform a secondary sensor capture process, to capture data representative of the surface plane of the sensor, wherein the captured data enables determination of whether the coating material has been successfully applied across the surface plane of the solar power infrastructure unit substantially along either the longitudinal axis or the lateral axis.

Preferably the solar power infrastructure unit includes either: a single solar panel; or multiple solar panels coupled thereby to define an array. Preferably the coating material is a coating material configured and/or formulated to reduce electrical output of the solar power infrastructure unit.

According to another aspect of the invention, there is provided a system for applying a coating to a solar power infrastructure unit, the system including: an Unmanned Aerial Vehicle (UAV) including: an input module configured to wirelessly receive control instructions from a control unit, wherein the control instructions include data representative of a predefined flight plan; a flight control module configured to execute the predefined flight plan; and a dispensing module/apparatus that is configured to dispense a coating material, wherein the dispensing module is configured to be actuated into a dispensing mode responsive to the predefined flight plan; a control module configured to: enable identification of a solar power infrastructure unit via a unique identifier representative of the solar power infrastructure unit; based on the unique identifier representative of the solar power infrastructure unit, access data configured to enable defining of flight plan data for a flight plan that is configured to cause application of the coating material across the surface plane of the solar power infrastructure unit substantially along either a longitudinal axis or a lateral axis of a surface plane of the solar power infrastructure unit; and transmit the defined flight plan data to the UAV.

Preferably the system includes an infrastructure monitoring module that is configured to receive data representative of a change in solar power infrastructure unit performance following a dispensing portion of the flight plan configured to cause application of the coating material across the surface plane of the solar power infrastructure unit. Preferably the infrastructure monitoring module is configured to cause rendering of representative of a change in solar power infrastructure unit performance following execution of the dispensing portion of the flight plan via a user interface. Preferably the flight plan includes a first flight plan component including the dispensing portion and a second flight plan component configured to perform a secondary sensor capture process, thereby to capture data representative of the surface plane of the sensor, wherein the captured data enables generation of the data representative of a change in solar power infrastructure unit performance following execution of the flight plan. Preferably the secondary sensor capture process includes operating a UAV-equipped sensor device thereby to observe one or more of the following: a change in optically observable characteristics of the solar infrastructure unit following the first flight plan component; a change in infrared characteristics of the solar power unit following the first flight plan component; a change in thermal characteristics of the solar power unit following the first flight plan component; and a change in a wireless signal following the first flight plan component.

Preferably the data representative of a change in solar power infrastructure unit performance following execution of the dispensing portion of the flight plan is defined based on a process configured to determine whether the coating material has been successfully applied across the surface plane of the solar power infrastructure unit substantially along either the longitudinal axis or the lateral axis. Preferably the data representative of a change in solar power infrastructure unit performance following execution of the dispensing portion of the flight plan enables a determination of whether the coating material has been successfully applied across the surface plane of the solar power infrastructure unit substantially along either the longitudinal axis or the lateral axis. Preferably the data representative of a change in solar power infrastructure unit performance following the dispensing portion of the flight plan includes data provided by a transmitter beacon coupled to the solar power infrastructure unit.

Preferably the transmitter beacon is configured to provide a signal having predefined attributes only when electrical output of the solar power infrastructure unit exceeds a predefined threshold. Preferably the beacon is coupled to a power supply provided by the solar power infrastructure unit, wherein the coupling is configured such that the beacon is at least partially deactivated upon electrical output of the solar power infrastructure unit ceasing to exceed the predefined threshold. Preferably the beacon is coupled to a power supply provided by the solar power infrastructure unit, wherein the coupling is configured such that the beacon is able to provide the wireless signal for at least a limited time period upon electrical output of the solar power infrastructure unit ceasing to exceed the predefined threshold.

Preferably coating material is configured and/or formulated to affect the electrical output of the solar infrastructure unit, and wherein the beacon is configured to enable remote identification of electrical output of the solar power infrastructure unit ceasing to exceed the predefined threshold.

Preferably the control module is configured to: (i) receive the unique identifier; (ii) cause querying of a database based on the unique identifier thereby to obtain query results; and (iii) based on the query results define the flight plan data. Preferably the query results include GPS waypoints for a flight plan. Preferably the query results are representative of location and/or orientation for the solar power infrastructure unit. Preferably the unique identifier is read from a wireless beacon. Preferably the unique identifier is identified via operation of a user interface device based on a geolocational process. Preferably the geolocational process includes accessing a map interface which displays locations of a plurality of solar power infrastructure units.

Preferably the solar power infrastructure unit includes either: a single solar panel; or multiple solar panels coupled thereby to define an array. Preferably the coating material is a coating material configured or formulated to reduce electrical output of the solar power infrastructure unit.

According to yet another aspect of the invention, there is provided a system configured to enable management of a solar power infrastructure unit, the system including: a beacon device configured to transmit a wireless signal, wherein the beacon device is coupled to a power output of the solar power infrastructure unit; wherein the beacon device is configured to transmit, via the wireless signal, data that is representative of (i) a unique identifier for solar power infrastructure unit; and (ii) an operational status of the solar power infrastructure unit, such that the data is able to be processed by a remote computing device; and wherein the beacon device is configured such that, in response to a predefined threshold reduction in electrical output of the solar power infrastructure unit, the wireless signal is modified thereby to enable identification, by the remote computing device, of the predefined threshold reduction in electrical output of the solar power infrastructure unit.

Preferably the coupling of the beacon device to the power output of the solar power infrastructure unit is configured such that, in response to the threshold reduction in electrical output of the solar power infrastructure unit, the beacon device no longer provides the wireless signal, and wherein the modification of the wireless signal includes termination of transmission of the wireless signal.

Preferably the system includes a database that associates the unique identifier with data representative of attributes of the solar power infrastructure unit. Preferably the data representative of attributes of the solar power infrastructure unit includes a location of the solar power infrastructure unit. Preferably the data representative of attributes of the solar power infrastructure unit includes a location and orientation of the solar power infrastructure unit. Preferably the data representative of attributes of the solar power infrastructure unit includes data configured to enable defining of flight plan data for a flight plan that is configured to cause application of the coating material across the surface plane of the solar power infrastructure unit substantially along either a longitudinal axis or a lateral axis of a surface plane of the solar power infrastructure unit. Preferably the data representative of attributes of the solar power infrastructure unit includes flight plan data for a flight plan that is configured to cause application of the coating material across the surface plane of the solar power infrastructure unit substantially along either a longitudinal axis or a lateral axis of a surface plane of the solar power infrastructure unit. Preferably the flight plan data includes a plurality of GPS waypoints.

Preferably the solar power infrastructure unit includes either: a single solar panel; or multiple solar panels coupled thereby to define an array. Preferably the coating material is a coating material configured or formulated to reduce electrical output of the solar power infrastructure unit.

According to yet another aspect of the invention, there is provided a method for operating a UAV, the method including: programming the UAV with a flight plan and dispenser actuating instructions thereby to cause dispensing of a coating fluid from a UAV onto a solar power infrastructure unit.

According to yet another aspect of the invention, there is provided a method for managing a solar power infrastructure unit, the method including applying a coating material via a UAV.

According to yet another aspect of the invention, there is provided a method for managing a solar power infrastructure unit, the method including applying a coating material, and operating a UAV thereby to determine whether the coating material is successfully applied.

According to yet another aspect of the invention, there is provided a system including a database that maintains: (i) unique identifiers for a plurality of solar power infrastructure unit, and (ii) for each solar power infrastructure unit, data representative of a flight plan for a UAV having a coating dispenser unit, wherein the flight plan is configured to cause application of a coating material across a surface of the solar power infrastructure unit.

According to yet another aspect of the invention, there is provided a solar power infrastructure unit coupled to a beacon device, wherein the beacon device is configured to transmit a signal that allows unique identification of the solar power infrastructure unit only in the case that electrical output is above a predefined threshold.

According to yet another aspect of the invention, there is provided a solar power infrastructure unit coupled to a beacon device, wherein the beacon device is configured to transmit a signal that allows unique identification of the solar power infrastructure unit only and enables remote identification of electrical output of the solar power infrastructure unit falling below a predetermined threshold.

According to yet another aspect of the invention, there is provided an apparatus for applying a coating material to a solar power infrastructure unit, comprising: an unmanned aerial vehicle (UAV); and a dispensing apparatus attached to the UAV for dispensing the coating material to coat the solar power infrastructure unit; wherein the UAV is configured to dispense coating material on the solar power infrastructure unit until an electrical output is substantially reduced.

According to yet another aspect of the invention, there is provided an apparatus, method and system as substantially described herein with reference to the accompanying figures and associated detailed description.

### BRIEF DESCRIPTION OF THE DRAWINGS

Embodiments of the invention will now be described, by way of example only, with reference to the accompanying drawings in which:

FIGS. 1A to 1C illustrate frameworks and schematic diagrams according to example embodiments.

FIG. 2 illustrates an example method.

### DETAILED DESCRIPTION

The present invention relates to apparatus/devices, systems and methodologies configured to enable management electrical output of solar energy infrastructure. For example, the term “management” is used to encompass activities including (but not limited to): the application of a coating material to a solar power infrastructure unit; and identification of a change in panel performance in response to application of such a coating material.

As used herein, the term “solar power infrastructure unit” is used to describe a single solar panel, or a solar array defined by a plurality of solar panels. The term is also used in an abbreviated form: “solar unit”. Where the solar unit is defined by an array of solar panels, the individual panels of the array may be (but are not necessarily) coupled to a common power output.

A given solar unit has a measurable electrical output. The term “electrical output” is used to describe any measurable electrical output property, for example a property measured in amperage and/or voltage and/or wattage. Embodiments have been developed thereby to assist in situations, such as fires and/or floods, where there is a desire to neutralise solar infrastructure for safety reasons. In this regard, the term “neutralise” means to bring electrical output (for example a value measured in a property measured in amperage and/or voltage and/or wattage) below a predetermined threshold level. The predetermined threshold level may be defined by reference to an objective safety standard.

Technology described herein is of particular utility for a solar unit in a “challenging” location, for example a location where it is difficult to either: apply a coating material to the panel for neutralisation purposes; and/or ascertain whether application of a coating to a panel has been achieved successfully, with the term “successfully” being used to describe application that causes neutralisation in the sense of bringing electrical output (for example a value measured in a property measured in amperage and/or voltage and/or wattage) below a predetermined threshold level.

Some embodiments provide technology configured to enable operation of an Unmanned Aerial Vehicle (UAV) or drone thereby to cause dispensing of a coating material to a solar unit. The term UAV should be read broadly, to include substantially any form of UAV (for example fixed wing, rotor driven, and hybrid). For the present purposes, substantially any form of UAV may be used, provided the UAV has the following elements: (i) a flight control module capable of receiving and/or defining data representative of a flight plan (for example a waypoint-based flight plan); (ii) a repository or reservoir for containing a dispensable fluid; (iii) a dispenser module or dispensing apparatus configured to cause dispensing (for example via a nozzle) of the dispensable fluid; and (iv) a dispenser actuation/control module configured to control actuation of the dispenser module, for example in response to an instruction provided by the flight control module or in response to a GPS based trigger. It will be appreciated that there are numerous known UAVs having these elements; the technology is described in a manner that remains neutral to the precise form of UAV that is used. However, it will be appreciated that the precise manner by which a flight plan is defined and dispensing is actuated will depend on specific attributes of a drone, for example flight velocity, dispensing trajectory and/or dispensing altitude. For UAVs purposely configured for dispensing applications, such control is conventionally pre-programmed, thereby to enable precision targeting for a dispensed fluid. Furthermore, those skilled in the art will understand how algorithms are used thereby to use inputs such as altitude above target, wind velocity and drone velocity thereby to achieve accuracy in dispensing operations. Such algorithms fall outside the scope of the present description, but will be well known to skilled persons familiar with UAV technology.

The inventor has surprisingly found that such numerous, known UAV/drones require substantial inventive adaptations and improvements to their apparatus, systems and methods of use in order to perform the invention described herein.

By way of example, embodiments of the present technology include, but are not limited to, the following:
A method for operating a UAV, the method including: programming the UAV with a flight plan and dispenser actuating instructions thereby to cause dispensing of a specialised coating fluid from a UAV onto a solar power infrastructure unit.
A method for managing a solar power infrastructure unit, the method including applying a specialised coating material via a UAV.
A method for managing a solar power infrastructure unit, the method including applying a specialised coating material, and operating a UAV thereby to determine whether the coating material is successfully applied.
A system including a database that maintains: (i) unique identifiers for a plurality of solar power infrastructure unit, and (ii) for each solar power infrastructure unit, data representative of a flight plan for a UAV having a coating dispenser unit, wherein the flight plan is configured to cause application of a specialised coating material across a surface of the solar power infrastructure unit.
An apparatus for applying the specialised coating material to the solar power infrastructure unit, that comprises an UAV with a dispensing apparatus attached to the UAV for dispensing the coating material onto the solar power infrastructure unit. The UAV is configured to dispense coating material on the solar power infrastructure unit until an electrical output is substantially reduced.
A solar power infrastructure unit coupled to a beacon device, wherein the beacon device is configured to transmit a signal that allows unique identification of the solar power infrastructure unit only in the case that electrical output is above a predefined threshold.
A solar power infrastructure unit coupled to a beacon device, wherein the beacon device is configured to transmit a signal that allows unique identification of the solar power infrastructure unit only and enables remote identification of electrical output of the solar power infrastructure unit falling below a predetermined threshold.

More detailed embodiments are described below. It will be appreciated, however, that were specific details are set forth, those are examples only, and not to be taken as being limiting upon all embodiments. That is, in further embodiments subsets and/or combinations of elements described below are combined and/or interchanged.

Technology embodying various aspects of the intention is described below by reference to systems, devices, and modules.

The term “module” refers to a software component that is logically separable (a computer program), or a hardware component. The module of the embodiment refers to not only a module in the computer program but also a module in a hardware configuration. The discussion of the embodiment also serves as the discussion of computer programs for causing the modules to function (including a program that causes a computer to execute each step, a program that causes the computer to function as means, and a program that causes the computer to implement each function), and as the discussion of a system and a method. For convenience of explanation, the phrases “stores information,” “causes information to be stored,” and other phrases equivalent thereto are used. If the embodiment is a computer program, these phrases are intended to express “causes a memory device to store information” or “controls a memory device to cause the memory device to store information.” The modules may correspond to the functions in a one-to-one correspondence. In a software implementation, one module may form one program or multiple modules may form one program. One module may form multiple programs. Multiple modules may be executed by a single computer. A single module may be executed by multiple computers in a distributed environment or a parallel environment. One module may include another module. In the discussion that follows, the term “connection” refers to not only a physical connection but also a logical connection (such as an exchange of data, instructions, and data reference relationship). The term “predetermined” means that something is decided in advance of a process of interest. The term “predetermined” is thus intended to refer to something that is decided in advance of a process of interest in the embodiment. Even after a process in the embodiment has started, the term “predetermined” refers to something that is decided in advance of a process of interest depending on a condition or a status of the embodiment at the present point of time or depending on a condition or status heretofore continuing down to the present point of time. If “predetermined values” are plural, the predetermined values may be different from each other, or two or more of the predetermined values (including all the values) may be equal to each other. A statement that “if A, B is to be performed” is intended to mean “that it is determined whether something is A, and that if something is determined as A, an action B is to be carried out”. The statement becomes meaningless if the determination as to whether something is A is not performed.

The term “system” refers to an arrangement where multiple computers, hardware configurations, and devices are interconnected via a communication network (including a one-to-one communication connection). The term “system”, and the term “device”, also refer to an arrangement that includes a single computer, a hardware configuration, and a device. The system does not include a social system that is a social “arrangement” formulated by humans.

At each process performed by a module, or at one of the processes performed by a module, information as a process target is read from a memory device, the information is then processed, and the process results are written onto the memory device. A description related to the reading of the information from the memory device prior to the process and the writing of the processed information onto the memory device subsequent to the process may be omitted as appropriate. The memory devices may include a hard disk, a random-access memory (RAM), an external storage medium, a memory device connected via a communication network, and a ledger within a CPU (Central Processing Unit).

### Example Frameworks/Figures

A selection of example frameworks/FIGURES are described below. These are provided as context to more detailed technical description further below; they provide the physical hardware infrastructure required to implement technology of various embodiments.

Across the examples, corresponding reference numerals are used to designate similar features. In each case, the system is configured (or configurable) to address either or both of the following technical problems: (i) application of a coating via UAV to a solar unit; (ii) determination of whether the application is successful (in the sense of threshold electrical neutralisation); and (iii) an apparatus that includes an UAV adapted and improved to coat the solar unit with the specialised coating material for electrical neutralisation.

In overview, a general objective is to apply a strip of the coating material along either a longitudinal or lateral axis of a solar unit (such application being is predicted to cause threshold neutralisation, for example using a coating as described in PCT patent application publication number WO/2014/015360), and to assess whether the application is successful (which is in various embodiments achieved via monitoring of electrical output properties and/or post dispensing observation of the solar unit surface via optical/IR/other means).

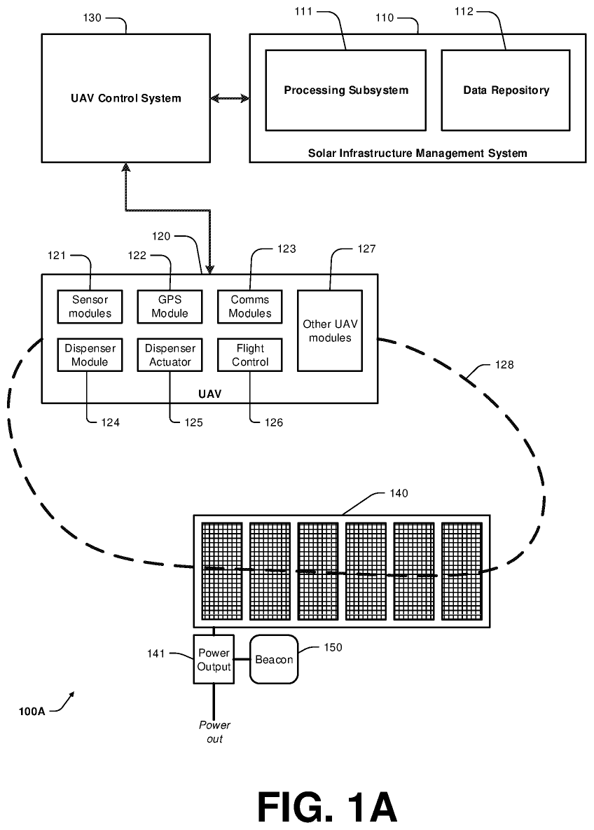

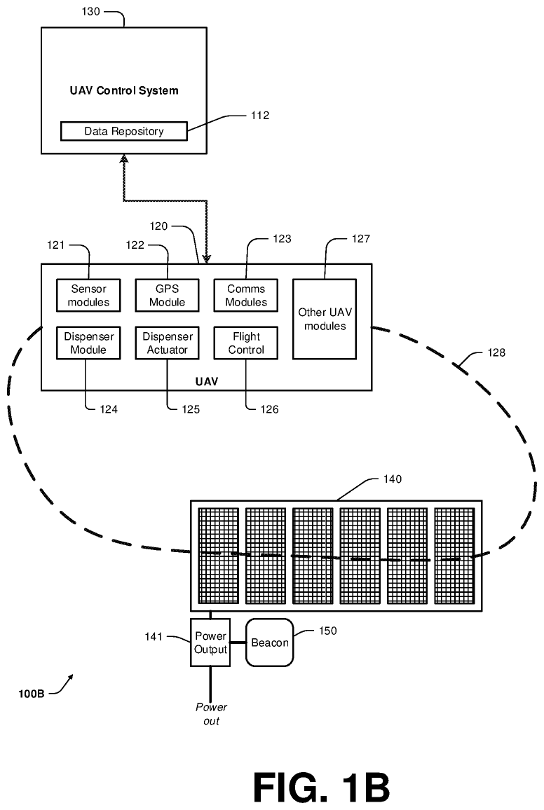

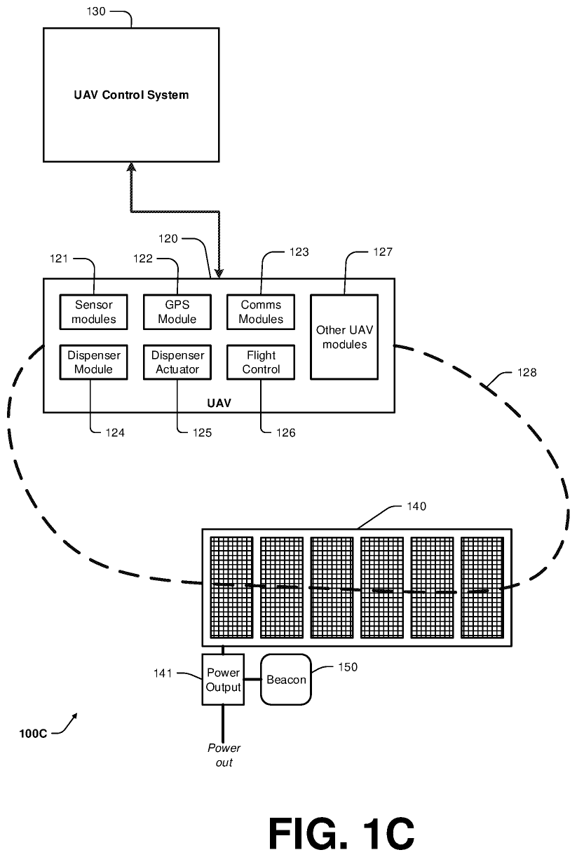

FIG. 1A illustrates an example framework 100A according to one embodiment.

System 100A includes a solar unit management system 110, a UAV 120, a UAV control system 130, a solar unit 140, and a solar unit wireless transmitter beacon 150. In overview, in this embodiment UAV 120 is controlled via control system 130, thereby to perform a flight that causes application of a coating material to solar unit 140. That is, FIG. 1A shows the UAV system schematics as well as the UAV interacting with a solar panel 140.

Solar unit 140 of FIG. 1A is illustrated as a rectangular array of rectangular panels, as an example only. The panels are connected to a common power output 141. As described in more detail further below, a wireless transmitter beacon 150 is coupled to power output 141.

UAV control system 130 may be either a centralised control system, as is common for many larger fixed-wing UAVs, or a local control system (for example a radio frequency controller coupled to a tablet device of the user), as is common for quad-copters and other short-range UAVs. It will be appreciated that the precise nature of control system depends on the UAV used, and that the technology described herein is able to be executed via a range of dispenser-equipped UAVs. In some embodiments a combination of local and centralised control is used.

UAV 120 is illustrated in block form only, intended to be representative of substantially any UAV having the illustrated functional components. These components are:
Sensor modules 121, for example a vision system, infrared sensors, and the like.
A GPS module 122.
Communications modules 123, for example radio modules (for example used for UAV control), and other modules (for example Bluetooth/WiFi/BLE modules configured to receive a signal from a Bluetooth/WiFi/BLE beacon).
A dispenser module/apparatus 124 and associated dispenser actuator module 125, which together are configured to enable controlled dispensing of the coating material.
A flight control module 126, which is configured to receive flight commands (for example flight plan data, manual commands, and the like), and convert those into signals for driving UAV flight hardware (such as propellers).
Other UAV modules 127, such as motors, telemetry systems, etc, which vary between UAV devices.

Line 128 is intended to illustrate a general UAV flight path, defined as a loop with transversely traverses above a solar surface of solar unit 140. This is not intended to represent a real-world flight path.

Solar unit data management system 110 includes a processing subsystem 111 (for example one or more networked computing devices which execute computer executable code thereby to provide software that enables functionalities described herein) and a data repository 112. Data repository 112 maintains information regarding a plurality of solar units. This information includes, for each solar unit (uniquely identifiable by an identifier) any one or more of the following:
(i) Information regarding location (for example GPS location) of the solar unit.
(ii) Information regarding orientation of the solar unit.
(iii) A flight plan (for example a GPS waypoint-based flight plan) is defined thereby to enable programming of a dispenser-equipped UAV cause application of a coating material across the surface plane of the solar unit substantially (for example along either a longitudinal axis or a lateral axis). In some embodiments multiple sets of flight plan data are defined, for example thereby to store and make available flight plan specific to multiple different UAV devices having different control/operational requirements.

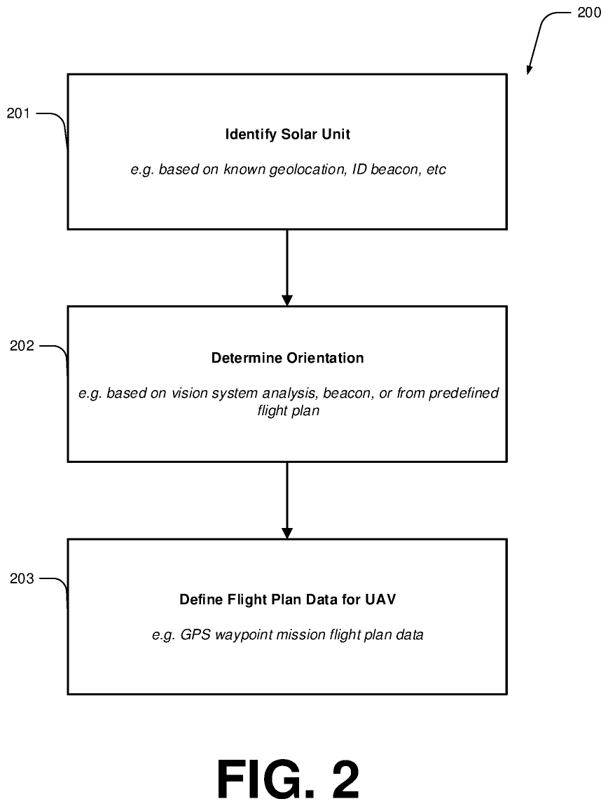

In embodiments where the data is limited to (i), or (i) and (ii), a UAV is configured to identify the solar unit, and define a flight plan based on locally collected sensor data. For example, that may include visual and/or IR sensing thereby to identify a precise location and orientation, followed by a flight plan defining process which causes a flight plan transversely (or longitudinally) above the surface plane of the solar unit, with dispensing timed to (if successful) create a strip of coating across either the lateral or longitudinal axis of the surface of the solar unit. By way of example, an operator operates a computing device that provides a map-based interface which displays solar unit locations (based on GPS locations), thereby to identify a desired solar unit to which a coating is to be applied. The operator then defines a first flight plan portion configured to navigate to the vicinity of the solar unit and obtain local data. Then, using the local data (for example optical data), a second flight plan portion is defined, this being a flight plan portion that includes the dispensing operation. This may be defined autonomously (or semi-autonomously, for example autonomous with a manual review and approval process) by the UAV, based on locally collected data (for example optical recognition to the solar unit, and/or other locally observed data that provides orientation and/or size information for the solar unit, for example a local transmitter beacon), or in some embodiments manually via POV flight controls. In some cases, a third flight plan component is defined (again either autonomously, semi-autonomously, thereby to enable observation (for example via optical/IR/other UAV carried sensors) thereby to enable determination of whether application of the coating was successful. We refer further below with respect to FIG. 2 and the description below with respect to feedback and proportional control.

It will be readily appreciated that alternatively or in addition to the local transmitter beacon described herein, markers to the spatial extent of a solar unit 140 may also be used by the UAV 120. For example optical and/or RFID markers located at the edges of a solar panel array 140 may be used by the UAV to map the extent of the array and then determine a dispensing pattern for the coating material. The markers may also be used for position confirmation of the UAV with respect to the solar panel array 140 during coating.

In embodiments where the data includes (iii), a UAV is able to be programmed with flight plan data for a given solar unit. For example, such flight plan data is defined as part of a solar unit installation and commissioning process. This is optionally achieved via various flight plan means, including via the setting of GPS waypoints (e.g. via a map-based interface executing on a handheld or other form of computing device). In this manner, system 110 provides a central repository for flight plan data able to be applied to a UAV, thereby to cause configuration of the UAV with predefined flight plan data thereby to apply a coating material to a specified solar unit.

In the example of framework 100B of FIG. 1B, management system 110 is omitted, and data repository 112 is programmed into UAV control system 130 (thereby allowing offline operation). In this manner, software used to perform UAV control maintains a local database that associated solar unit IDs with information such as (i), (ii) and/or (iii) above. For example, where information of type (iii) is present, an operator of controller 130 identifies a desired solar unit (for example via a location-based search, a known ID, proximity, etc), and is able to identify flight plan data. It will be appreciated that, where GPS-based waypoint data is used, the amount of actual data is minimal, rendering it generally unproblematic for a local data store covering a large number of solar units to be stored on a portable device.

In the example of framework 100C of FIG. 10, management system 110 is omitted, and instead of using data repository 112, beacon 150 is configured to transmit data such as (i), (ii) and/or (iii) above via a wireless signal (which is in some embodiments read by UAV 120, and in other embodiments read by UAV control system 130, and in further embodiments read by a non-illustrated device). For example, this allows beacon 150 to provide (either in response to a trigger signal, or on a continuous basis) flight plan data (such as GPS-based waypoint data) for a flight plan that is intended to enable application of the coating material to solar unit 140. This also allows for offline operation; each solar unit is inherently locally programmed, (via a respective beacon) with data that allows for defining of a flight path for coating application purposes.

In another example based on FIG. 10, beacon 150 adopts a less complex role, and is used to assist with identifying one or more of: solar unit location (for example by a predefined beacon-to-unit positional mountain regime); optionally orientation (again based on known positioning of the beacon relative to the solar unit); unit attributes (for example dimensions, etc); and/or GPS-defined attributes. This information enables automated determination of a flight plan for coating application purposes. For example, this information allows a UAV controller to determine positional data (for example GPS positional data) for waypoints on a flight plan, including waypoints at which coating dispensing is to be actuated.

### Example Methods

Example methods of operating an Unmanned Aerial Vehicle (UAV) for applying a coating to a solar power infrastructure unit are described below. Each of these methods include a common set of steps, shown in FIG. 2, where:
Block 201 represents identifying the solar power infrastructure unit. By way of example, this optionally includes identification via a database based on known attributes (such as location), and/or identification via local identifying means (for example via a local transmitter beacon).
Block 202 represents processing input data thereby to determine an orientation of the solar infrastructure unit, wherein the orientation defines a longitudinal axis and a lateral axis of a surface plane. This optionally includes implicit orientation determination (for example where orientation is determined from a pre-defined flight plan data available in a data repository) and/or explicit orientation determination (for example where vision systems, local transmitter beacons and/or other means are used thereby to enable local determination of solar unit orientation).
Block 203 represents defining a flight plan that is configured to enable dispensing of a coating material from the UAV, wherein the flight plan is defined thereby to cause application of the coating material across the surface plane of the solar power infrastructure unit substantially along either the longitudinal axis or the lateral axis. For example, the flight plan is defined based on predefined flight plan data accessed from an information repository, or defined based on local observations (for example local observations of location, size and/or orientation).

It will be appreciated that various elements of the example methods disclosed below are able to be interchanged thereby to define further examples. For example, with respect to feedback and proportional control as described below.

In one example, solar units are commissioned with data to facilitate UAV-based neutralisation by emergency assistance personnel. This includes, following installation of a solar unit, defining of GPS waypoints for a flight plan configured to cause dispensing of a coating fluid transversely across a surface of the unit, thereby to cause neutralisation (if executed successfully). This data is stored in a central repository, which is optionally made available for download to individual UAV control units (thereby to allow offline operation in the field). Emergency assistance personnel arrive at a site having one or more solar units which are required to be neutralised. The emergency assistance personnel are equipped with UAV equipment including a rotor-powered UAV (for example quad-copter or octo-copter) having a coating material storage and dispensing system. The UAV equipment additionally includes a UAV control device, having a display screen which renders a user interface. A UAV operator accesses the user interface thereby to identify a solar unit. For example, the user interface uses geolocation (e.g. via onboard GPS for the UAV and/or control unit) thereby to display a map interface, and the map interface shows icons representing known solar units in a proximal area (being units commissioned as described above). The operator selects one of those icons, and provides a command to execute a dispensing flight plan. This causes identification in a data repository (either cloud-based, server-based, or in local UAV control device memory) of GPS-based waypoint data for the flight plan defined during commissioning. The operator selects a command to execute the flight plan, which causes upload of the waypoint data to the UAV, and an instruction to the UAV to execute the flight plan. The UAV autonomously navigates to a first waypoint, and completes the resulting waypoint mission (which preferably includes dispensing operation, although in some embodiments dispenser actuation is manually controlled via a separate control signal based on manual monitoring of UAV progress through the waypoint mission flight plan). The waypoint mission preferably includes a secondary flyover, thereby to enable sensor-based assessment of mission success (for example as described further below).

In another example, solar units are commissioned with data to facilitate UAV-based neutralisation by emergency assistance personnel, however unlike the example above, UAV missions are coordinated from a central location using longer range UAVs. This includes, following installation of a solar unit, defining of GPS waypoints for a flight plan configured to cause dispensing of a coating fluid transversely across a surface of the unit, thereby to cause neutralisation (if executed successfully). This data is stored in a central repository, which is optionally made available for download to individual UAV control units (thereby to allow offline operation in the field). Emergency assistance personnel at a central location are informed of a site having one or more solar units which are required to be neutralised. The emergency assistance have access to long range (e.g. fixed wing) UAV equipment configured for coating material storage dispensing. An operator accesses a map interface rendered on a control terminal, and the map interface showing icons representing known solar units in a proximal area (being units commissioned as described above) in the vicinity of the identified site. The operator selects one of those icons, and provides a command to execute a dispensing flight plan. This causes identification in a data repository (either cloud-based, server-based, or in local UAV control device memory) of GPS-based waypoint data for the flight plan defined during commissioning. The operator selects a command to execute the flight plan, which causes upload of the waypoint data to the UAV, and an instruction to the UAV to execute the flight plan. The UAV autonomously navigates to a first waypoint, and completes the resulting waypoint mission (which preferably includes dispensing operation, although in some embodiments dispenser actuation is manually controlled via a separate control signal based on manual monitoring of UAV progress through the waypoint mission flight plan). The waypoint mission preferably includes a secondary flyover, thereby to enable sensor-based assessment of mission success (for example as described further below).

In one example, solar units are commissioned with data to facilitate UAV-based neutralisation by emergency assistance personnel. This includes, following installation of a solar unit, defining of GPS waypoints for a flight plan configured to cause dispensing of a coating fluid transversely across a surface of the unit, thereby to cause neutralisation (if executed successfully). This data is stored in a local device, which is configured to transmit the data (either continuously, or in response to a trigger) via a transmitter beacon. Emergency assistance personnel arrive at a site having one or more solar units which are required to be neutralised. The emergency assistance personnel are equipped with UAV equipment including a rotor-powered UAV (for example quad-copter or octo-copter) having a coating material storage and dispensing system. The UAV equipment additionally includes a UAV control device, having a display screen which renders a user interface. A UAV operator accesses the user interface thereby to identify a solar unit. In this example, this is achieved via reading one the beacon signal by the UAV control device (or, in an alternate example, by a UAV device that has been flown to a location proximal a solar unit for initial visual identification purposes, into a zone where a short-range beacon signal is readable). The beacon signal includes data for a waypoint mission flight plan. The operator selects a command to execute the flight plan, which causes upload of the waypoint data to the UAV, and an instruction to the UAV to execute the flight plan. The UAV autonomously navigates to a first waypoint, and completes the resulting waypoint mission (which preferably includes dispensing operation, although in some embodiments dispenser actuation is manually controlled via a separate control signal based on manual monitoring of UAV progress through the waypoint mission flight plan). The waypoint mission preferably includes a secondary flyover, thereby to enable sensor-based assessment of mission success (for example as described further below). Additionally/alternately, the beacon is configured to provide an indication of successful neutralisation (also described further below).

In a further example, the previous example as adapted for implementation via centrally-controlled UAV equipment. For instance, on-site personnel read a beacon signal read the local beacon signal, and transmit the read flight plan data to a central UAV control facility. In another use case, a UAV operator at a central location manually guides a UAV to a known emergency location, reads, via the UAV, a local beacon signal, and from that defines flight plan data for dispensing operation.

In another example, solar units are not commissioned. Emergency assistance personnel arrive at a site having one or more solar units which are required to be neutralised. The emergency assistance personnel are equipped with UAV equipment including a rotor-powered UAV (for example quad-copter or octo-copter) having a coating material storage and dispensing system. The UAV equipment additionally includes a UAV control device, having a display screen which renders a user interface. A UAV operator operates a UAV in a solar unit detection mode, wherein image processing software is configured to provide an object detection algorithm tuned to enable automated detection of a solar unit (for example based on shape/colour/other parameters, and in some cases via visually identifiable markings applied to solar units for detection purposes). The operator guides the UAV through a flight that places the solar unit in range of a camera device, and the UAV image processing software automatically recognises the solar unit. Following identification, the operator provides a “define flight plan” signal. The UAV then executes a flight, based on visual inputs, thereby to autonomously perform a solar unit flyover across a transverse axis of the unit surface (which preferably includes dispensing operation, although in some embodiments dispenser actuation is manually controlled via a separate control signal based on manual monitoring of UAV progress through the waypoint mission flight plan). The UAV software also preferably enables, via a secondary flyover, an analysis process that determines (for example via colour/reflectivity/heat/IR sensing) whether the coating was successfully applied. This may include an image-based analysis process.

### Determining Success of Coating Application

Some embodiments relate to determining success of a coating application operation. This may include: (i) determination of success of a drone operation via the dispensing drone (e.g. via visual and/or other sensors); (ii) determination of success of a non-drone spraying application via drone (e.g. via visual and/or other sensors); (iii) determination of success of a drone operation via a transmitter beacon; and (iv) determination of success of a non-drone spraying application via a transmitter beacon.

In relation to (i) and (ii), embodiments include a computer implemented method for receiving input data collected via a UAV (for example image data, heat/IR data, and/or other data), and processing that data thereby to identify a solar unit and determine whether a coating is applied transversely or otherwise across the solar unit. The other data may include a signal transmitted to the drone from an electrical output sensor for the solar unit/panel. Image processing algorithms configured to allow object recognition that allow automated identification of objects such as solar units are known. Such algorithms are enhanced for the present purposes by including one or more of: colour analysis; reflectivity analysis; and/or infrared profile analysis thereby to determine whether a coating having known properties extends transversely from edge to edge across a planar surface of a solar unit. In the case that the algorithm determines, with greater than a threshold probability, that the coating is applied transversely from edge to edge of the solar panel or group of solar panels, a “success” signal is generated. In some embodiments, a manual and/or automated flight plan is executed via the UAV thereby to capture of sensor data to facilitate execution of the algorithm. In the absence of a “success” signal the algorithm may direct the UAV and dispensing apparatus to re-apply the coating material to the solar unit, either for a prior transverse pass of the solar unit or multiple prior passes. That is the algorithm may operate in a feedback loop to apply successive layers of coating material to achieve the desired reduction in electrical output. Alternatively, or in addition the algorithm may enable proportional control of the dispensing apparatus, the speed of movement of the UAV and the path across the solar unit to provide a single pass, optimised layer to the solar unit as it coats the solar unit.

It will be readily appreciated that whilst a transverse, straight path across the solar unit panel/s has been described, other spray patterns across the solar unit may be used. For example, circular or elliptical paths across the solar panel/s.

A further example application area to the above is industrial, large scale solar farms that have possibly hundreds or more solar panels or arrays. The UAV may have optical sensors and/or cameras operating in the visible and infrared spectrums as well as a dispensing apparatus with the coating material. The UAV may be used to periodically inspect the solar panels of a farm, for example daily. Of particular interest is the use of the infra-red camera to autonomously identify adverse hot-spots on the solar panels. Adverse hot-spots on solar panels are often a precursor to a short circuit or other failure leading to arcing and then a fire. Alternatively, or in addition the solar cell hot-spot failure may propagate across the panel if not pre-emptively dealt with. The UAV once identifying an adverse hot-spot may then apply the coating material to either the solar panel with the hot-spot or the entire solar panel series or array. This would then prevent the development of a fire and further damage to other solar cells or other solar panels in the solar PV system or array as well as the solar farm. Once the affected solar panel has been either partially or fully coated a photographic image may be taken with the visible spectrum optical camera. The photograph of the affected solar panel may then be relayed to a central control centre for evaluation. In addition, the photograph image may be analysed by the UAV to confirm that the hot-spot region identified by the infra-red camera has been coated by the coating material. If there is a lack of correspondence the UAV may re-apply another layer of the coating material and/or re-examine the solar panel for hot-spots with the infra-red camera so as to repeat the process of above until the affected area is adequately coated and the solar PV system rendered electrically safe. In summary, the UAV with the dispensing apparatus and coating material may be used to identify, coat, isolate and verify pre-emptive action to an adverse hot-spot on a solar panel or solar PV system or array. The abbreviation “PV” refers to photovoltaic as commonly used in this technical field.

In relation to (iii) and (iv), embodiments include a beacon device, and method for operating a beacon device, and methods for processing data delivered from a beacon device, in the context of determining success of a coating application process for a solar unit. The beacon device is configured to transmit a wireless signal, for example via WiFi, Bluetooth, BLE, or alternate radio wave signal. The beacon device may also be coupled to an electrical power output of the solar power infrastructure unit. For example, the electrical output sensor may be voltage or current sensing as appropriate. In some embodiments the beacon device is used to assist in UAV dispensing missions, as described herein.

The beacon device is configured to transmit, via the wireless signal, data that is representative of (i) a unique identifier for solar power infrastructure unit; and (ii) an operational status of the solar power infrastructure unit, such that the data is able to be processed by a remote computing device. The operational status optionally includes multiple measured attributes, or a signal representing greater than threshold electrical output. Furthermore, the beacon device is configured such that, in response to a predefined threshold reduction in electrical output of the solar power infrastructure unit, the wireless signal is modified thereby to enable identification, by the remote computing device, of the predefined threshold reduction in electrical output of the solar power infrastructure unit.

In some embodiments, the coupling of the beacon device to the power output of the solar power infrastructure unit is configured such that, in response to the threshold reduction in electrical output of the solar power infrastructure unit, the beacon device no longer provides the wireless signal. In such cases, the “modification” of the wireless signal includes termination of transmission of the wireless signal. For example, this is achieved by configuring coupling of the beacon device to the power output such that the beacon device no longer receives adequate power for operation upon the threshold reduction. This allows straightforward identification of neutralisation; a signal representative of “problematic” electrical output ceases upon successful application of a neutralising coating.

In some embodiments, the coupling of the beacon device to the power output of the solar power infrastructure unit is configured such that, in response to the threshold reduction in electrical output of the solar power infrastructure unit, the beacon device transitions into a battery operated mode, and provides a modified wireless signal (which is indicative of the threshold reduction) For example, this is achieved by configuring coupling of the beacon device to the power output such that the beacon device no longer receives adequate power for operation upon the threshold reduction, and automatically transitions to batter power. Onboard logic is configured to, upon that transition, modify the transmitted signal to indicate and confirm that threshold power output reduction has been achieved.

### Coatings

Certain, preferable coating materials can be used by the UAV technology as described herein by way of example. These coating materials include compositions or formulations for coating the light-receiving area of the solar power infrastructure unit to reduce the amount of light being received by the solar panel's photovoltaic cells to reduce the electrical output. It will be readily appreciated that the example coating materials described here and also in PCT patent publication number WO 2014/015360A1 are suitable for use with a UAV as described herein, as well as other variations to the coating material composition and consequently to the UAV and dispensing apparatus and method.

Depending on the conditions when the UAV is in flight, it may be necessary to use an alternate, suitable composition which resists being removed in high wind conditions or washed off with water/rain, and will later be relatively easily released from the panel and any surrounding structures (e.g. roof tiles) upon which the coating composition has been applied. It will be appreciated that the coating of the invention is sacrificial and/or removable, in that it is designed to be applied and then removed when required, preferably as a single cohesive sheet and preferably without marking the solar power infrastructure unit or the surrounding structures. It will further be appreciated that the coating of the invention is preferably formulated to include fire retardant additives, and/or UV-stabilisers such that the coating does not degrade in strong sunlight, as some coatings will need to remain in place for many months or even years in the case of a building which is to remain unoccupied for extended periods of time. However, in other embodiments such as for immediate firefighting, the coating may contain no UV-stabilisers so that the coating will degrade and fall away over time. Preferably a film of the coating is not water soluble.

In one embodiment, the composition comprises a binder; and an opacifier, wherein said opacifier is included in a sufficient quantity such that a predetermined film thickness of said composition reduces light transmission therethrough such that the resulting electrical output of said solar power infrastructure unit is reduced to below a predetermined threshold level.

In relation to the coating composition, it will be appreciated that there is a relationship between film thickness and opacifier concentration to achieve a critical or predetermined reduction in sunlight transmission such that the resulting electrical output of the solar power infrastructure unit is reduced to below a predetermined threshold level, for example that a solar panel array is electrically safe. To explain, a greater thickness of deposited coating film will require a relatively reduced amount of opacifier to give said predetermined reduction in light transmission, and vice versa.

The present invention is not intended to be limited to a specific amount of opacifier or specific film thickness. It is contemplated that all combinations of film thickness and opacifier concentrations which provide the required reduction in sunlight transmission can be used. However, the coating composition should preferably have a high opacifier loading to maximise the reduction in light transmission and to minimise the amount of coating composition which is required to be applied.

As a person skilled in the art will be aware, an opacifier is a generally inert substance added to a coating system (in this case the binder) in order to make the coating system opaque and to reduce the transmission of incident light. Opacifiers typically have a refractive index substantially different from the binder, and titanium dioxide (in both anatase and rutile forms) and/or calcium carbonate are typically used as opacifiers in surface coatings. However, other opacifiers will be known to the skilled person, such as zinc oxide, talc, carbon black, expanded or expandable thermoplastic microspheres see by way of example Morehouse, U.S. Pat. No. 3,615,972, and “ROPAQUE OP-62”, manufactured by Rohm and Haas Company (see U.S. Pat. No. 4,427,836), and like materials. Preferably the sunlight transmission is reduced to 0%, or below 1, 2, 3, 4, 5, 10, 15, 20, 25, 30, 35, 40, 45, 50, 55 60, 65, 70 or 75% of the light received in the absence of the composition, i.e. the incident light. Preferably 100% of the light-receiving area is coated.

It will be appreciated that the composition reduces the amount of sunlight being received by the photovoltaic cells which in turn reduces the electrical output of the solar panel. In one preferred embodiment, a single coating is applied to achieve the predetermined or critical reduction in light transmission. However multiple coatings may be required.

The coating material and the use of a coating material to coat the surface of a solar power infrastructure unit blocks the incident sunlight transmitted to the photovoltaic cells to thereby effectively switch the solar power infrastructure units off. Preferably the coating reduces the electrical current to zero, or at least below a predetermined or threshold level such as below the physiological injury level as described by line b, page 22, Australian Standard 60479.1:2003, which is incorporated herein by reference. Preferably the solar panel is electrically neutralised, that is the electrical output is substantially zero and/or reduced to a level which is electrically safe. It will be appreciated that the present invention is directed at reduction of the DC current which is produced by the solar power infrastructure unit to below the threshold of perception, and/or to the threshold of reaction, as defined in the above Australian Standard. In some embodiments, it is an advantage of the present technology to reduce the probability of ventricular fibrillation to below 50%, preferably to below 5%, and more preferably to below 1%.

In one example test conducted in accordance with standards IEC 60904-1:2006 and IEC60904-3:2008 the maximum power was reduced from 268 W to OW and the open circuit voltage reduced from 38V to 0.2V for a solar panel array covered entirely with the coating material. In another example the test was done according to the EU (European Union) Environmental Technology Verification Pilot Programme General Verification Protocol, version 1.2—Jul. 27 2016 as well as version 1.3 and to the standard ISO14034:2016. In this latter test the output current from a solar panel array entirely covered in the coating material was reduced from 6.7 A DC to 0.2 A DC within 7 seconds from the start of the application of the coating material to the solar panel array. The output power from the inverter to the solar panel array was reduced from 1125 W to OW within 7 seconds of start of application. Further test results are given further below with respect to partial coverage of a solar panel array.

It will be appreciated that the coating composition is preferably formulated such that it is not electrically conductive.

Binders suitable in the coating composition are those which are water-based, as the coating composition could possibly be directed into or near a fire. It will be appreciated, however, that a minor amount of volatile organic compound (VOC) can be incorporated into the composition. In some embodiments, the binders are non-flammable. In one of the preferred coating compositions, water will account for about 20 to about 95 wt % of the composition and for ease of application, the composition may typically comprise about 50 to 90 wt % and most preferably about 60 to 85 wt % water in the final composition. In some embodiments, the combined non-volatile portions of the water-reducible film-forming coating composition of the invention will typically account for only about 5 wt %.

The binder of the coating composition comprises at least one water-reducible film-forming polymer. As used herein, the term “film-forming polymer” means that the polymer can form a continuous film upon evaporation of all solvent or carrier and/or upon cure of the polymer. As used herein, the term “water reducible” is meant to include all polymers which can be stably dispersed in water and is intended to include water-soluble polymers, dispersions, emulsions, and latices wherein the volatile content is, or can be, predominantly water.

Water-soluble polymers are generally understood in the art as those materials with sufficient hydrophilic and/or ionic groups (such as acid or amine groups) on the polymer to provide water solubility. For many applications it is preferred to utilize polymers having a number average molecular weight of at least about 2,000.

One common approach to producing water-soluble polymers is by the condensation reaction of reactants having a stoichiometric excess of ionic groups, such as acid or amine groups which can subsequently be neutralized to provide water solubility. Water-soluble polyesters, polyureas, polyurethanes and other polymers can be prepared in this manner.

For example, the condensation polymerization reaction of reactants having a stoichiometric excess of acid or anhydride groups with reactants having hydroxyl, amine and/or epoxy functionality can produce acid functional polymers which can be neutralized with a base, such as an amine to provide water solubility. Similarly, water-soluble polymers can be produced by the reaction of reactants having a stoichiometric excess of amine functionality with co-reactants such as polycarboxylic acids, polyepoxides, polyisocyanates and other materials to produce amine functional polymers which can be neutralized with acids to provide water solubility.

Another method well known in the art to produce water-soluble polymers is by the free radical polymerization of unsaturated groups having acid or amine functionality such as acrylic acid, methacrylic acid, dimethylaminoethyl acrylate, with other unsaturated monomers followed by neutralization of the ionic groups to provide water solubility.

Representative examples include water-reducible acrylic modified polyesters such as taught in U.S. Pat. No. 4,735,995; acid-functional air drying polyurethanes such as taught in U.S. Pat. No. 5,104,737, and polyurethane dispersions such as taught in U.S. Pat. Nos. 5,310,780 and 5,912,299.

Many other methods for producing water-soluble polymers are also known in the art. Representative commercially available water-soluble resins include Kelsol DV-5862, a water-reducible alkyd from Reichhold Chemicals and Rezimac WR 73-7331, a water-reducible epoxy resin from Eastman Chemical.

Other water-dispersible film-forming polymers include latex resins. Representative examples include styrene butadiene latices, polyvinyl acetate latices, acrylic latices, and many others. These types of polymers are frequently prepared by emulsion polymerization wherein the reactive monomers and appropriate initiators are emulsified in water in the presence of emulsifying agents to provide a stable dispersion of polymer particles in water. In some embodiments, it is especially useful to utilize latex resins which are more hydrophobic. These types of latices are representatively prepared by utilizing monomers that are more hydrophobic, and by using surfactants or emulsifying agents which are less water sensitive or which can be incorporated directly into the latex polymer itself.

Representative examples of some latices useful include the latex polymers taught in PCT application PCT/US99/23428 (WO 00/22016), entitled Latex Polymer Compositions; and U.S. Pat. No. 5,739,196. Representative commercially available latex resins useful in the practice of this invention include Rhoplex®. Multilobe 200 (acrylic latex), Rhoplex®. AC-264 (acrylic latex) both from Rohm and Haas Company, and Neocar®. 2300 (vinyl versatate based latex), UCAR®. 651 (acrylic copolymer), Ultracryl®. 701 (acrylic latex), Neocar®. 820 (acrylic latex), and Neocar®. 7657 and 7658 (hydrophobic acrylic latices) all available from Union Carbide Corporation.

Preferably the binder has a Tg (glass transition temperature) below room temperature and is therefore rubbery.

Preferably the composition is formulated to have a low surface tension in order to enable it to adhere and to wet the surface to which it is being applied. Surface tension modifiers can be included in the coating composition so as to improve coat-ability. Surface tension modifiers lower the surface tension of the composition so that the composition will “wet” the substrate thereby facilitating the application process. Useful surface tension modifiers include those marketed under the trade names Surfynol® 104 and Surfynol® TG available from Air Products and Chemicals Inc. The major ingredient in these surface tension modifiers is: 2, 4, 7, 9,-tetramethyl-5-decyne-4,7,diol. Other surface tension modifiers and mixtures of modifiers can also be used.

Preferably the composition is adapted to be sprayable from a distance onto solar panels. The preferred coating composition is formulated to be sprayable from a distance onto a solar power infrastructure unit. In some embodiments, the distance will be relatively small, such as 1 to 2 meters, but in other cases the distance will be greater, and could be 2, 3, 4, 5, 6, 7, 8, 9, 10 or even 15 metres. Delivery of the coating material from greater distances may be necessary if the solar power infrastructure unit itself, or structures in close proximity to the solar power infrastructure unit are on fire and relatively close access is not possible.

Alternatively, there may be structures surrounding the solar power infrastructure unit that inhibit close access, such as power lines or high-tension cables, and moving the UAV into close proximity could damage the UAV itself.

In some embodiments, the solar power infrastructure unit will need to be coated from a safe distance, which could be 5, 10, 15, 20 or more metres away, and could even be at an elevated height, such as on the top of a 2-story roof or multi-storey building

In some preferred embodiments, the composition is formulated to have a rheological profile such that the composition is delivered as a “jet” or a stream (rather than atomising) when discharged from the spray apparatus on the UAV. This embodiment is particularly useful when the coating composition is to be delivered onto a solar power infrastructure unit from a significant distance, such as between 2 and 15 metres. Preferably the composition remains substantially in jet form for a distance up to 2, 4, 6, 8, 10 or even 15 metres. Preferably the diameter of the stream is about 4 to 6 mm, about 6 to 8 mm, about 8 to 10 mm, about 15 mm, about 20 mm or about 30 mm. In some embodiments, the stream is a continuous stream. In other embodiments, the composition is formulated to have a rheological profile such that the composition is delivered in an atomised form or fine mist (rather than as a “jet” or a stream) when discharged from the spray apparatus on the UAV. This embodiment is particularly useful when the coating composition is to be delivered onto a solar panel from relatively small distance away, such as 1 to 2 metres. In this embodiment, preferably the composition remains substantially in atomised form once dispensed from the UAV. The atomised coating composition can be conveniently delivered such that the final coating thickness is between 20 and 1000 micrometres, such as between 100 and 500 micrometres. In some embodiments, the final coating thickness of the composition is between about 90 to 500 microns. However, preferred film thicknesses are around 5, 10, 25, 50, 75, 100, 150, 200, 250, and 500 micron.

In some embodiments, the composition is formulated to have a low viscosity under high shear conditions (i.e., when being sprayed or otherwise dispersed onto the solar panel), and high viscosity under low shear conditions, such as once deposited onto the panel and in the repository on-board the UAV.

In some preferred embodiments, the composition is formulated to have a rheological profile such that the composition remains as a thick viscous fluid when on-board the UAV. This can assist to avoid “sloshing” effects thereby minimising any negative effects on the UAV during travel and motion to a change in load distribution. However, in other embodiments, the coating composition is formulated to have a rheological profile such that the composition remains as a relatively thin fluid (having a viscosity close to water) when on-board the UAV. In this case the UAV repository can be adapted with internal compartments or other suitable structures or dampeners that mitigate sloshing effects.

It will be appreciated that the composition is preferably adapted to stay in place once deposited and resist sagging or running, as any significant flow of the composition once deposited will result in a reduction in thickness of the final film and therefore have the potential to increase the light being be transmitted through to the light-receiving area of the solar power infrastructure unit.

In preferred embodiments, the composition is formulated to have a viscosity when stored (i.e., in the repository) of 20, 25, 30, 35, 40, 45, 50, 55, 60, 65 or 70 Pa·s. In other embodiments, the composition is formulated to have a viscosity when stored (i.e., in the repository) of 80, 85, 90, 95, 100, 105, 110, 115, 120, 125, 130, 140, 150, 200, 300, 400 or 500 Pa·s. Preferably the composition is formulated to have a viscosity when applied (i.e., drying with good levelling and minimum sag) of 2, 3, 4, 5, 6, 7, 8, 9, 10, 11, 12, 13, 14, or 15 Pa·s. Preferably the composition is formulated to have a viscosity during application (i.e., during spraying) of 0.05, 0.10, 0.15, 0.20, 0.25, 0.30, 0.35, 0.40, 0.45, or 0.50 Pa·s. In another embodiment, the composition is formulated to have a viscosity during application (i.e., during spraying) of 1.0, 1.5, 2.0, 2.5, 3.0, 3.5, 4.0, 4.5 or 5.0 Pa·s. Viscosities are measured with Spindle 3 at 10 rpm and at 19° C.

It will be appreciated by a person skilled in the art that any suitable rheology modifier can be used which provides the desired viscosity of the coating composition. The rheology modifiers can be natural or synthetic. In some embodiments, the rheology modifier is a polysaccharide. Suitable rheology modifiers are selected from the group consisting of alginic acid, sodium alginate, potassium alginate, ammonium alginate, calcium alginate, agar, carrageenan, locust bean gum, pectin, gelatin, fumed silica, fine talc, chalk, polyethylene glycol, polyacrylic acid, petroleum jelly, waxes, polyurethanes, latex, styrene/butadiene, polyvinyl alcohol, clays, casein, collagen, castor oil, organosilicones. Combinations of rheology modifiers can be utilised to fine-tune the required rheology profile as discussed herein.

Preferably the composition is also adapted to substantially remain in a substantially homogeneous suspension when awaiting use or for long periods of time. This is preferred as emergency workers will not have time to stir the ingredients back into suspension when they arrive at an incident.

Preferably the composition is adapted to dry quickly, and for example is tacky within 1-5 mins and substantially dry within 5-10 mins. In order to achieve tackiness within a predetermined time, preferably the binder includes one or more crosslinker. Persons skilled in the art will be aware of suitable such crosslinkers.

Preferably the resultant dried film is coherent, in that it can be relatively easily peeled away from a non-porous surface as a single sheet. This feature enables the film to be relatively easily removed after the solar panel has been treated/coated to electrically neutralise it, and enables the solar power infrastructure unit to be reused. Preferably a “release agent” is incorporated into the composition. Such release agents are well known to the skilled person, and include materials such as silicone-containing compounds. Preferably the composition includes additives to improve the fire resistance of the coating composition. Such additives are well known to the skilled person, and include materials such as ceramic microspheres, mono ammonium phosphate or vermiculite.

In some preferred embodiments, the composition is absent UV inhibitors, or includes additives which increase or accelerate the UV-destruction of the resultant film. This embodiment is particularly useful in case where access to the solar power infrastructure unit is difficult and where the intention is to turn off the solar power infrastructure unit but allow power generation to resume after a short period of time. Preferably the composition is adapted such that a film of the coating composition is substantially degraded by sunlight within about 2 to 6 weeks. In this embodiment, once the resultant film has served its useful life and is no longer needed, the action of the sun will degrade the film and it will become friable and fall away in the wind and rain. This is especially useful as any overspray which is deposited onto porous substrates such as concrete tiles etc, will likely be somewhat absorbed therein and will resist peeling away. Therefore, the absence of a UV inhibitor or the presence of a decomposition accelerant will ‘remediate’ the over-sprayed areas with time. In some embodiments, however, a relatively high amount of UV inhibitor is included so that the film is not degraded by sunlight so that the solar power infrastructure unit remains electrically inactive for extended periods of time.

In some preferred embodiments, the composition includes release agents thereby allowing the coating film to be relatively easily peeled away from the surface upon which it has been applied. Such additives will be well known to the skilled person.

As discussed, the coating is adapted to prevent light transmission through a wet or dried film thereof, but also preferably provides a tenacious tough film when dried which can be relatively easily peeled from a substrate. Accordingly, in some embodiments the composition is formulated to either have a relatively high loading of opacifiers which are chosen to reduce or inhibit light transmission through the film, or are chosen to have a high degree of light reflectance. Opacifier concentrations between 5 and 50% are possible, but the opacifier is typically incorporated at around 5-20 wt %. It will also be readily appreciated that an intermediate coating may be formed on the solar power unit, for example a gelatinous or jell like coating.

It will also be appreciated that in some cases, the coating composition used in the present technology can simply be poured onto the solar power infrastructure unit by the repository for containing the dispensable fluid of the UAV.

In relation to the spray apparatus to deliver a coating composition suitable for coating the light receiving area of a solar power infrastructure unit, in one embodiment a discharge nozzle is provided in fluid communication with the repository (i.e., reservoir). The discharge nozzle comprises a nozzle housing defining a central flow passage having a discharge end and an inlet end, the inlet end in fluid communication with a discharge valve assembly. In one embodiment, the discharge end of the central passage is an outlet orifice that produces little, if any atomization, but directs a continuous or broken stream of the coating composition/material. The outlet orifice is sized to produce a predetermined diameter of the stream of coating composition, for example an adjustable nozzle that can vary the stream from a continuous or a broken stream to a spray. In another embodiment, the outlet orifice is a shaped orifice that uses a semi-spherical shaped inlet and a V notched outlet to cause the flow to spread out on the axis of the V notch to generate a flat fan spray of coating composition.

In another embodiment, the outlet orifice directs a stream of coating composition onto an impingement surface to result in a sheet of coating composition that breaks up into droplets. One particularly preferred embodiment utilises an impingement surface comprising a rotating disc having a plurality of radially extending channels or grooves. The droplet size is controllable by controlling the speed of rotation of the disc. Droplet sizes of 10 micrometres to 5,000 micrometres in diameter are possible by controlling the speed of rotation of the disc. Other discharge nozzles will be known to those skilled in the art.

It will be appreciated that any suitable rotational speed can be used for the rotating disc to provide the appropriate droplet diameter and/or coating thickness. Preferred rotational speeds of the rotating disc are between about 5 to 15,000 rpm, preferably between 100 to 10,000 rpm and more preferably between 1,000 to 13,000 rpm. The upper values being suitable for providing an atomised or fine mist dispersal of the coating material.

It will also be appreciated that any suitable flow rate of the stream of coating composition from the outlet orifice can be used to break up the stream into droplets having appropriate diameter. Preferably, the flow rate of the stream from the outlet orifice is between 0.005 to 20 L/s, preferably between 0.01 to 15 L/s and more preferably 0.012 to 1.0 L/s.

In some embodiments, the dispenser module of the UAV is capable of containing a volume of the coating composition and delivering a short burst of the coating composition under high pressure and delivering that quantity in a relatively confined stream or jet. In this way, a pulse of coating composition can be delivered relatively accurately onto the solar panel with minimal overspray and wastage. It will also be appreciated that in some embodiments, the coating composition is adapted to enable to it to be delivered as a cohesive (continuous) jet of fluid. In other words, the coating composition is adapted to avoid atomisation when delivered via a nozzle. This can be achieved by controlling the rheological profile of the coating composition. In other embodiments, the dispenser module/apparatus delivers the coating composition by atomisation to form droplets.

Whilst the coating composition can be any colour, preferably the composition is coloured with a pigment which provides a readily noticeable colour against the colour of a typical roof, e.g. bright orange, blue, red or pink This makes it relatively easy for users (e.g. firefighting personnel) of the UAV to see where the composition has been applied and to ensure that the solar panel is well covered. This also provides a clearly visible signal to others that the panel has been covered and the dwelling is electrically safe (at least from the solar panel). In some embodiments, however, the composition may be coloured white, black or grey.

It is also particularly advantageous to select an appropriate coating composition colour in that it can give a real-time indication of the electrical output of the solar cells. To explain, once the mains power to the dwelling has been switched off, the power output of the dwelling can be measured by a fire fighter, emergency services worker or electrical contractor (at the mains/utility box) whilst another fire fighter, emergency services worker or electrical contractor is coating the panels. Because the electrical response of the solar cells is almost instantaneous, the coating composition can be continuously applied until the person monitoring the electrical power box reports that the power has been reduced to zero, or to below a level which causes harmful physiological effects. This gives some confidence or verification to the fire fighters that sufficient coating has been applied and that the electrical power level is indeed reduced, whereas otherwise it would simply be a guess or remain an unknown.

In some preferred embodiments, the UAV delivers a substantially consistent coating across the entire light receiving area of the solar power infrastructure unit. However, in other embodiments, the UAV delivers a strip or band of coating composition that extends from one side of the light receiving area of the solar power infrastructure unit to the opposite side of the light receiving area of the solar power infrastructure unit. The width of the strip or band may be 10, 20, 30, 40, 50, 60, 70 or 80% of the total length of said side. It has been surprisingly found that, in some cases, a solar power infrastructure unit can be electrically inactivated by applying a strip or band of coating material (rather than applying a coating to the entire light receiving area of the solar power infrastructure unit). In preferred embodiments the strip or band is positioned to extend approximately across the middle of the light receiving area of the solar power infrastructure unit. In one example 40% of a solar panel array was covered by a band of the coating material that extended across the middle of the rectangular solar panel array, from one long side to the other long side. In this test example the maximum power was reduced from 268 W to OW and the open circuit voltage reduced from 38V to 6.5V. The test for this example was done according to the standards IEC 60904-1:2006 and IEC60904-3:2008.

In preferred embodiments, the coating composition comprises a homogenised blend of polymers and pigments with activators, flame retardants and adhesion adjustors to act as a removable extinguishing agent. The coating forms a solid blanket to block light resulting in shut-down of electrical output of a solar power infrastructure unit.

### CONCLUSIONS

It will be appreciated that the technology described above provides significant technical advancements in the context of managing solar infrastructure, for example in the context of coating-based electrical output neutralisation of solar panels.

### Interpretation.

Example embodiments of the invention are provided in the claims below. Embodiments include devices and frameworks described herein (and aspects/elements thereof), methods described herein (and aspects/elements thereof) and computer program products and/or non-transitory carrier medium for carrying computer executable code that, when executed on a processor, causes the processor to perform a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fibre optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIGURE, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A method of operating an Unmanned Aerial Vehicle (UAV) for applying a coating to a solar power infrastructure unit, the method including:
identifying the solar power infrastructure unit;
processing input data thereby to determine an orientation of the solar infrastructure unit, wherein the orientation defines a longitudinal axis and a lateral axis of a surface plane; and
defining a flight plan that is configured to enable dispensing of a coating material from the UAV;
wherein the flight plan is defined to cause application of the coating material across the surface plane of the solar power infrastructure unit substantially along either the longitudinal axis or the lateral axis.

2. A method according to claim 1 wherein identifying the solar power unit includes identifying a signal emitted by a transmitter beacon, wherein the identifying is performed by the UAV or by a control device that is in communication with the UAV.

3.-4. (canceled)

5. A method according to claim 2 wherein the transmitter beacon is located at a defined position relative to the solar panel, wherein the defined location enables determination of the orientation and defining of the flight plan.

6. (canceled)

7. A method according to claim 5 wherein the signal emitted by the transmitted beacon performs at least one of the following functions:
enables identification of data representative of the defined position b) provides data that is processed thereby to define the flight plan; and
c) enables accessing of data thereby to define a waypoint-based flight plan.

8.-9. (canceled)

10. A method according to claim 7 wherein the transmitter beacon is configured to provide a signal having predefined attributes only when electrical output of the solar power infrastructure unit exceeds a predefined threshold and wherein the beacon is coupled to a power supply provided by the solar power infrastructure unit, wherein the coupling is configured such that the beacon is at least partially deactivated and able to provide the wireless signal for at least a limited time period upon electrical output of the solar power infrastructure unit ceasing to exceed the predefined threshold.

11.-12. (canceled)

13. A method according to claim 2 wherein coating material is configured or formulated to affect the electrical output of the solar infrastructure unit, and wherein the beacon is configured to enable remote identification of electrical output of the solar power infrastructure unit ceasing to exceed the predefined threshold.

14. (canceled)

15. A method according to claim 2 wherein the signal emitted by the transmitter beacon is representative of, or provides access to, data including any one of the following:
a unique identifier for the solar power infrastructure unit;
operational attributes of the solar power infrastructure unit;
a location of the solar power infrastructure unit;
orientation of the solar power infrastructure unit relative to known parameters; and
a predefined flight plan configured for applying the coating to the solar power infrastructure unit.

16. A method according to claim 1 wherein processing input data thereby to determine an orientation of the solar infrastructure unit, wherein the orientation defines a longitudinal axis and a lateral axis of a surface plane includes processing input data collected by a sensor device of the UAV, and wherein the sensor device includes an optical sensor device or an infrared sensor device.

17. (canceled)

18. A method according to claim 1 wherein the flight plan additionally includes a flight plan component configured to perform a secondary sensor capture process, thereby to capture data representative of the surface plane of the sensor, wherein the captured data enables determination of whether the coating material has been successfully applied across the surface plane of the solar power infrastructure unit substantially along either the longitudinal axis or the lateral axis.

19. A method according to claim 1 wherein the solar power infrastructure unit includes either: a single solar panel; or multiple solar panels coupled thereby to define an array.

20. (canceled)

21. A system for applying a coating to a solar power infrastructure unit, the system including:
an Unmanned Aerial Vehicle (UAV) including:
an input module configured to wirelessly receive control instructions from a control unit, wherein the control instructions include data representative of a predefined flight plan;
a flight control module configured to execute the predefined flight plan; and
a dispensing module/apparatus that is configured to dispense a coating material, wherein the dispensing module is configured to be actuated into a dispensing mode responsive to the predefined flight plan;
a control module configured to:
enable identification of a solar power infrastructure unit via a unique identifier representative of the solar power infrastructure unit;
based on the unique identifier representative of the solar power infrastructure unit, access data configured to enable defining of flight plan data for a flight plan that is configured to cause application of the coating material across the surface plane of the solar power infrastructure unit substantially along either a longitudinal axis or a lateral axis of a surface plane of the solar power infrastructure unit; and
transmit the defined flight plan data to the UAV.

22. A system according to claim 21 including an infrastructure monitoring module that is configured to receive data representative of a change in solar power infrastructure unit performance following a dispensing portion of the flight plan configured to cause application of the coating material across the surface plane of the solar power infrastructure unit, wherein the infrastructure monitoring module is configured to cause rendering of representative of a change in solar power infrastructure unit performance following execution of the dispensing portion of the flight plan via a user interface.

23. (canceled)

24. A system according to claim 22 wherein the flight plan includes a first flight plan component including the dispensing portion and a second flight plan component configured to perform a secondary sensor capture process, thereby to capture data representative of the surface plane of the sensor, wherein the captured data enables generation of the data representative of a change in solar power infrastructure unit performance following execution of the flight plan.

25. A system according to claim 24 wherein the secondary sensor capture process includes operating a UAV-equipped sensor device thereby to observe one or more of the following:
(i) a change in optically observable characteristics of the solar infrastructure unit following the first flight plan component;
(ii) a change in infrared characteristics of the solar power unit following the first flight plan component;
(iii) a change in thermal characteristics of the solar power unit following the first flight plan component; and
(iv) a change in a wireless signal following the first flight plan component.

26. A system according to claim 22 wherein the data representative of a change in solar power infrastructure unit performance following execution of the dispensing portion of the flight plan is defined based on a process configured to determine or enables a determination of whether the coating material has been successfully applied across the surface plane of the solar power infrastructure unit substantially along either the longitudinal axis or the lateral axis and includes data provided by a transmitter beacon coupled to the solar power infrastructure unit.

27.-28. (canceled)

29. A system according to claim 28 wherein the transmitter beacon is configured to provide a signal having predefined attributes only when electrical output of the solar power infrastructure unit exceeds a predefined threshold and wherein the beacon is coupled to a power supply provided by the solar power infrastructure unit, wherein the coupling is configured such that the beacon is at least partially deactivated and able to provide the wireless signal for at least a limited time period upon electrical output of the solar power infrastructure unit ceasing to exceed the predefined threshold.

30.-31. (canceled)

32. A system according to claim 29 wherein coating material is configured to affect the electrical output of the solar infrastructure unit, and wherein the beacon is configured to enable remote identification of electrical output of the solar power infrastructure unit ceasing to exceed the predefined threshold.

33. A system according to claim 21 wherein the control module is configured to: (i) receive the unique identifier; (ii) cause querying of a database based on the unique identifier thereby to obtain query results; and (iii) based on the query results define the flight plan data; wherein the query results include GPS waypoints for a flight plan and are representative of location and/or orientation for the solar power infrastructure unit.

34.-35. (canceled)

36. A system according to claim 34 wherein the unique identifier is read from a wireless beacon and identified via operation of a user interface device based on a geolocational process which includes accessing a map interface which displays a locations of a plurality of solar power infrastructure units.

37.-56. (canceled)

57. An apparatus for applying a coating material to a solar power infrastructure unit, comprising:
an unmanned aerial vehicle (UAV); and
a dispensing apparatus attached to the UAV for dispensing the coating material to coat the solar power infrastructure unit;
wherein the UAV is configured to dispense coating material on the solar power infrastructure unit until an electrical output is substantially reduced.

58. (canceled)
